(19) United States
(12) Patent Application Publication
(10) Pub. No.: US 2025/0103006 A1
(43) Pub. Date: Mar. 27, 2025

(54) TIMEPIECE REGULATING MEMBER COMPRISING AN IMPROVED INDEX SYSTEM

(71) Applicant: ETA SA MANUFACTURE HORLOGÈRE SUISSE, Grenchen (CH)

(72) Inventor: Julien CHRISTAN, Biel/Bienne (CH)

(73) Assignee: ETA SA MANUFACTURE HORLOGÈRE SUISSE, Grenchen (CH)

(21) Appl. No.: 18/819,297

(22) Filed: Aug. 29, 2024

(30) Foreign Application Priority Data
Sep. 26, 2023 (EP) 23199680.2

(51) Int. Cl. G04B 18/06; G04B 17/32

(52) U.S. Cl. CPC G04B 18/06; G04B 17/325

(57) ABSTRACT

A regulating member (1) for a horological movement including an inertial mass, for example a balance (23), a balance spring (25), a balance bridge (22), and an index system (20) for adjusting the rate of the balance spring (25), the index system (20) including a stud-holder (31) including a first stud (34) on which the balance spring (25) is mounted. The balance bridge (33) includes a second stud on which the balance spring (25) is also mounted, the stud-holder (31) being rotatable relative to the balance bridge (33) in order to adjust the rate of the regulating member (1).

### CROSS REFERENCE TO RELATED APPLICATIONS

This application claims priority to European Patent Application No. 23199680.2 filed Sep. 26, 2023, the entire contents of which are incorporated herein by reference.

### TECHNICAL FIELD OF THE INVENTION

The invention relates to the field of watchmaking, and more particularly to the field of mechanical watchmaking, where the regulation of the driving energy is provided by a regulating member. More specifically, the invention relates to a regulating member provided with a precision index system, a horological movement comprising such a regulating member, and a timepiece comprising such a horological movement.

### TECHNOLOGICAL BACKGROUND

In most mechanical watches, the energy required to rotate the hands (for example the minute and hour hands) is stored in a barrel and then delivered by a sprung balance system, which comprises a flywheel called a balance, combined with a spring in the form of a spirally wound ribbon called a balance spring.

An inside end of the balance spring is attached to a staff that rotates as one with the balance; an outside end of the balance spring is attached to a stud mounted on a stud-holder that is itself rigidly connected to a stationary bridge.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

In a conventional escapement mechanism, the oscillation frequency is around 4 Hz, or approximately 28,800 vibrations per hour (V/h). One of the objectives of good watchmakers is to ensure the isochronism and regularity of the oscillations (or constancy of rate) of the balance.

The rate of the balance can be regulated in a known manner by adjusting the active length of the balance spring, defined as the curvilinear length between its inside end and a counting point, located in the vicinity of the outside end of the balance spring and typically defined by a pair of bankings carried by a key mounted on an index system.

In operation, this index system is not able to rotate about the axis of the balance spring. However, its angular position can be adjusted by manual intervention, for example by pivoting an eccentric acting like a cam on the index system using a screwdriver.

The assembly comprising the bridge, the index system, the key, the stud-holder, the stud, the staff, the spring and the balance is commonly referred to as the “regulating member”. Examples of regulating members are given in the European patent EP3304215 and in the European patent EP2876504, both filed by the watch manufacturer ETA.

There are index systems which have a stud-holder to which an outside end of the balance spring is attached, and where the index system key leaves play to allow the balance spring to move between the two bankings. However, the chronometric properties, in particular the anisochronism, are very sensitive to play at the index key, and this play is difficult to control precisely.

In some devices, the bankings can be adjusted to clamp the balance spring in order to eliminate play, particularly when the balance spring is in operation. In this case, first the rate is regulated by moving the index key, then clamping the balance spring to the key. However, clamping the balance spring to the index key risks stressing it and creating chronometric errors, in particular due to the off-centring of the windings. Moreover, removing the play also changes the rate, and once the balance spring has been clamped, you can no longer move the index key along the balance spring to finish fine-tuning the rate.

Other balance springs have an integrated regulating device. In these balance springs, the rate is not regulated by altering the effective length of the balance spring, but by applying a force or torque to a flexible element arranged in series with the balance spring. In this way, the stiffness of the flexible element and consequently of the balance spring as a whole can be modified. Adjusting the stiffness of the balance spring allows the rate of the regulating member to be regulated. Such a balance spring provided with a flexible element is described, for example, in the patent application EP4009115.

However, in these cases, usual index systems cannot be used, as they are not compatible with the balance spring regulating device. Moreover, as the rate has to be regulated to a very fine degree, it is essential that there is no play between the balance spring and the areas where it interacts with the index mechanism. More specifically, if this were not the case, there would be a risk of the rate being altered in the event of an impact, if the balance spring does not reposition itself in exactly the same way after the impact.

### SUMMARY OF THE INVENTION

The aim of the present invention is to overcome some or all of the above-mentioned drawbacks by providing an index system compatible with this type of regulating device.

To this end, the invention relates to a regulating member for a horological movement comprising an inertial mass, for example a balance, a balance spring, a balance bridge, and an index system for adjusting the rate of the regulating member, the index system comprising a stud-holder including a first stud on which the balance spring is mounted.

The invention is characterised in that the balance bridge includes a second stud on which the balance spring is also mounted, the stud-holder being rotatable relative to the balance bridge in order to adjust the rate of the regulating member.

Thanks to the invention, the rate of the regulating member can be adjusted simply by changing the position of the stud-holder, as this changes the position of the first stud in relation to the second stud, which remains unmoving in relation to the plate. As the balance spring is carried by the two studs, the stiffness of the balance spring is altered. As the position of the second stud is not changed, the guide mark remains unchanged.

In a particular embodiment of the invention, the index system comprises a return spring exerting a spreading force between the stud-holder and the balance bridge.

In a particular embodiment of the invention, the stud-holder and the spring are in one piece, preferably made of the same material.

In a particular embodiment of the invention, the index system comprises a rotatable cam, the cam cooperating with the stud-holder to rotate it.

In a particular embodiment of the invention, the stud-holder comprises an arm in contact with the cam so that the stud-holder can be rotated.

In a particular embodiment of the invention, the balance spring comprises a coiled ribbon and means for adjusting the stiffness of the balance spring, which means are provided with a flexible element arranged in series with the coiled ribbon, the second stud being mechanically connected to the flexible element.

In a particular embodiment of the invention, the flexible element is connected to a rigid support, the second stud being integral with the rigid support.

In a particular embodiment of the invention, the adjustment means comprise prestressing means for applying a variable force or torque to the flexible element, the first stud being mechanically connected to the prestressing means.

In a particular embodiment of the invention, the flexible element and the prestressing means are arranged between the first stud and the second stud, the first stud being movable relative to the second stud to actuate the prestressing means, the displacement of the first stud relative to the second stud modifying the stiffness of the balance spring.

In a particular embodiment of the invention, the prestressing means include a lever connected to the flexible element, the first stud being integral with a free end of the lever.

In a particular embodiment of the invention, the prestressing means include a rigid structure arranged in parallel with the flexible element, the lever being connected to the rigid structure.

In a particular embodiment of the invention, the flexible element is connected to a rigid support, the second stud being integral with the rigid support.

In a particular embodiment of the invention, the stud-holder is arranged on the balance bridge around a bearing on the balance staff.

The invention further relates to a horological movement comprising such a regulating member.

The invention further relates to a timepiece, for example a watch, comprising such a horological movement.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a perspective, top view of a regulating member according to a first embodiment of the invention,

FIG. 2 diagrammatically shows a perspective, top, partially disassembled view of the first embodiment of the regulating member in FIG. 1,

FIG. 3 diagrammatically shows a top view of a balance spring of the regulating member according to the invention,

FIG. 4 diagrammatically shows a perspective, bottom, partially disassembled view of the first embodiment of the regulating member shown in FIG. 1,

FIG. 5 diagrammatically shows a bottom view of the first embodiment of the regulating member shown in FIG. 1,

FIG. 6 diagrammatically shows a perspective, partial, top view of a regulating member according to a second embodiment of the invention,

FIG. 7 diagrammatically shows a partial, enlarged view of a part of the second embodiment of the regulating member shown in FIG. 6, and

FIG. 8 diagrammatically shows a perspective, top view of the stud-holder of the second embodiment of the regulating member shown in FIG. 6.

### DETAILED DESCRIPTION OF THE INVENTION

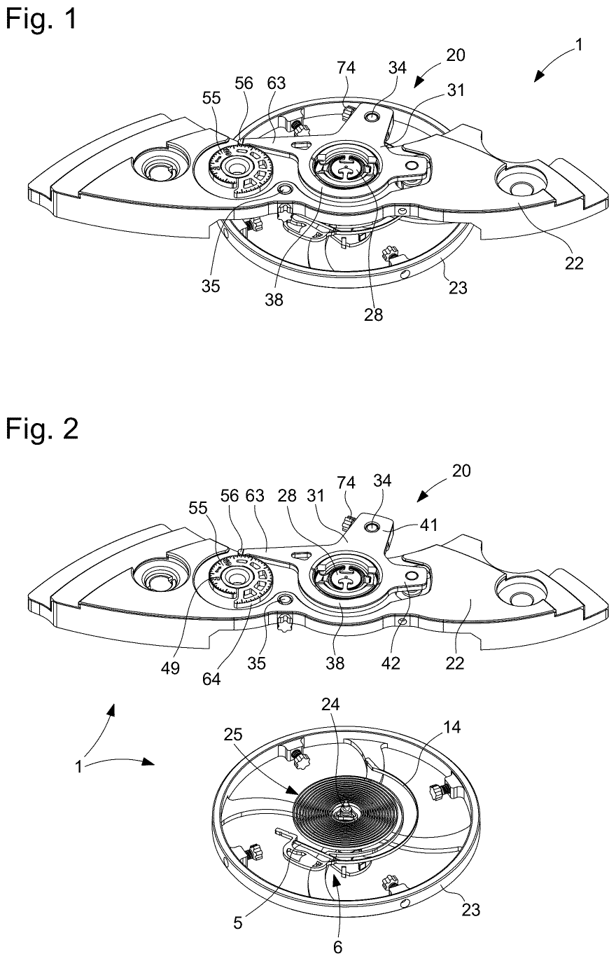

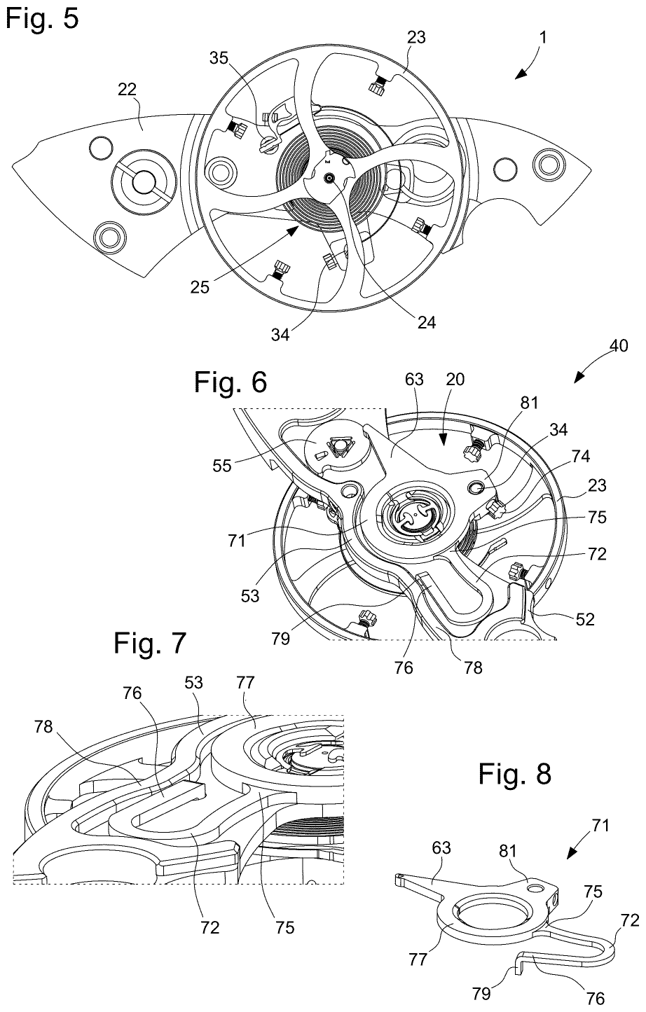

FIGS. 1 to 5 diagrammatically show a first embodiment of a regulating member 1 intended to be arranged in a horological movement not shown in the figures. Such a horological movement comprises, for example, a plate provided with a recess for receiving the regulating member 1, the regulating member 1 being provided with an inertial mass, and a resilient return element for the inertial mass configured to cause it to oscillate.

The regulating member 1 further comprises an index system 20, an annular balance 23 as an inertial mass, a balance staff 24, a balance spring 25 as a resilient return element, and a balance bridge 22.

In FIGS. 1 to 3, the balance 23, the balance spring 25, the balance bridge 22 and the index system 20 are stacked, in this case from bottom to top.

The balance staff 24 is centred and passes through the centre of the balance 23, of the balance spring 25 and of the balance bridge 22. The balance staff 24 is held by two shock-resistant bearings 28 arranged at both ends of the balance staff 24. A first bearing, not shown in the figures, is arranged under the balance 23 and the balance bridge 22, and the second bearing 28 is held by the balance bridge 22. The balance bridge 22 is provided with a hole, in this case a through-hole, in which the second bearing 28 is held. The index system 20 is mounted on the balance bridge 22 and is arranged, in this embodiment, along the central axis of the balance staff 24.

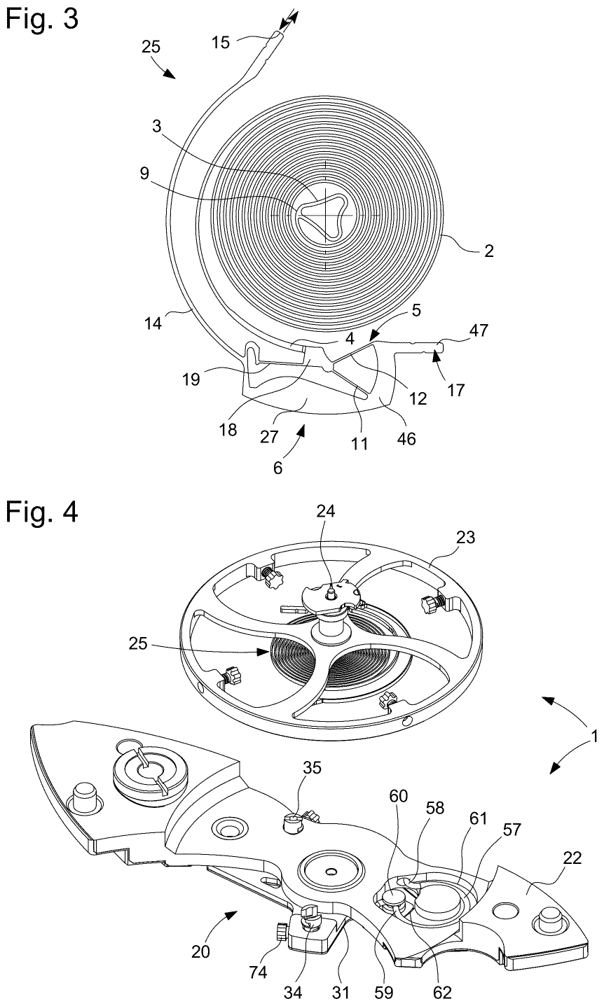

FIG. 3 shows an example of a balance spring 25 which preferably extends substantially in one plane. The balance spring 25 comprises a flexible ribbon 2 wound about itself in several turns, the ribbon 2 having a predefined stiffness. The inside end 9 of the ribbon 2 is integral with or assembled with a support 3, typically referred to as a collet. The support 3 is substantially triangular in shape and is threaded around the staff of the balance 24.

The balance spring 25 further includes means for adjusting its stiffness. For example, the adjustment means can in particular be actuated by an operator when the regulating member is mounted on the plate of the horological movement.

The adjustment means include a flexible element 5 arranged in series with the ribbon 2, with the flexible element 5 connecting one end 4 of said ribbon 2 to a rigid support 17, and integral with one of the ends 4 of the ribbon 2. The flexible element 5 is integral with the outside end 4 of the ribbon 2. The flexible element 5 is a different element from the ribbon 2.

The flexible element 5 adds additional stiffness to that of the ribbon 2. The flexible element 5 is preferably stiffer than the ribbon 2. In this case, the flexible element 5 is arranged as an extension of the ribbon 2. Preferably, the adjustment means and the ribbon 2 are in one piece, or even made of the same material, for example silicon.

The flexible element 5 of the balance spring 25 comprises a pivot with non-crossing flexible blades. The pivot comprises two non-crossing flexible blades 11, 12 and a rigid part 18. The flexible blades 11, 12 are on the one hand joined laterally to a rigid support 17, and on the other to the rigid part 18 by moving towards each other. Thus, the flexible blades 11, 12 preferably extend away from the rigid part 18 as far as the rigid support 17. The outside end 4 of the ribbon 2 is joined to the rigid part 18. The rigid support 17 is unmoving relative to the plate. The rigid support 17 is L-shaped, with a first leg 46 of the L serving as a connection to the flexible blades 11, 12, and the second leg 47 of the L facing away from the pivot with non-crossing blades so that it can be assembled to the horological movement.

The means for adjusting the balance spring 25 further include prestressing means 6 for applying a variable force or torque to the flexible element 5. In this way, the stiffness of the balance spring can be adjusted. The torque or force is continuously adjustable thanks to the prestressing means 6. In other words, the torque or force is not restricted to isolated values. The stiffness of the flexible element 5 can thus be adjusted with great precision.

The prestressing means 6 include a secondary flexible blade 19, arranged on an opposite side of the rigid part 18 in the extension of the pivot with non-crossing blades. The secondary flexible blade 19 is arranged tangentially to the ribbon 2, at the outside end 4.

The other end of the secondary flexible blade 19 is connected to a curved lever 14 which runs around the ribbon 2. The lever 14 is connected, in addition to the secondary flexible blade 19, to a rigid structure 27 attached to the rigid support 17. The rigid structure 27 deforms in part when the lever 14 is actuated by the force or torque.

The force or torque is exerted on the free end 15 of the lever 14. In this way, the lever 14 of the prestressing means 6 transmits the force or torque to the flexible element 5 via the secondary flexible blade 19 and the rigid structure 27, so as to modify the stiffness of the balance spring 25.

In FIGS. 1 and 2, the balance spring 25 has a different configuration. The non-crossing blades 11, 12, the rigid part 18 and the secondary flexible blade 19 are replaced by a single blade, with the outside end 4 of the lever 14 being attached to the single blade.

In order to be able to apply the variable force or torque to the balance spring 25, the regulating member comprises an index system 20.

In the first embodiment shown in FIGS. 1, 2, 4 and 5, the index system 20 is fitted with a stud-holder 31 provided with a first stud 34.

According to the invention, the balance bridge 22 is provided with a second stud 35. The stud-holder 31 is mechanically connected to the lever 14 of the prestressing means 6, but it does not block the ribbon 2.

The stud-holder 31 is in contact with the balance bridge 22, and is held and positioned by the shock absorber 28.

The stud-holder 31 can rotate about the balance staff relative to the balance bridge 22, so that it can move the first stud 34 and act on the lever 14.

The stud-holder 31 comprises a central ring 38 arranged around the second bearing 28.

The stud-holder 31 comprises two protrusions 41, 42, extending radially from the central ring 38, a first protrusion 41 holding the first stud 34 down by means of a first screw 74. The second protrusion 42 holds the second stud 35 down by means of a second screw.

In a reference arrangement, the first stud 34 and the second stud 35 are, for example, arranged substantially symmetrically relative to the staff of the balance 24.

The first stud 34 cooperates with the free end 15 of the lever 14, and the second stud 35 cooperates with the second leg 47 of the rigid support 17. Thus, the prestressing means 6 are supported by the index system 20, and the flexible element 5 by the balance bridge 22, from which they are suspended.

The two studs 34, 35 are arranged on either side of the prestressing means 6 and of the flexible element 5. Moreover, the two studs 34, 35 are rigidly connected to the lever 14 and to the rigid support 17. In other words, the first stud 34 and second stud 35 are respectively integral with the lever 14 by the free end 15 and with the rigid support 17 by the second leg 47. The studs and the balance spring 25 are assembled, for example, by bonding, brazing, welding, by deformation of metallic glass, or by mechanical fastening.

The first stud 34 is movable relative to the second stud 35. To this end, the stud-holder 31 is movable relative to the balance bridge 22. The stud-holder 31 can rotate about the second bearing 28. Thus, the first stud 34 moves with the stud-holder 31, the first stud 34 being rotatable about the second bearing 28. The first stud 34 can, for example, be displaced over an angular range of 20° or even 10°.

The displacement of the first stud 34 relative to the second stud 35 modifies the stiffness of the flexible element 5, as the displacement exerts a greater or lesser force or torque on the lever 14 of the prestressing means 6, so that the stiffness of the flexible element 5 varies, and thus the stiffness of the balance spring 25 as a whole also varies. The index system 20 thus allows the rate of the regulating member 1 to be regulated.

To this end, the index system 20 allows the position of the first stud 34 to be changed relative to the second stud 35. The stud-holder 31 moves relative to the balance bridge 22, and as a result, the first stud 34 moves relative to the second stud 35 to modify the force or torque applied to the prestressing means 6 of the balance spring 25.

The stud-holder 31 of the index system 20 comprises an arm 63 extending radially outwards in one plane.

The index system 20 includes a rotatable cam 55 arranged on the balance bridge 22. The cam 55 cooperates with the arm 63 of the stud-holder 31 to cause it to rotate about the second bearing 28. The end 56 of the arm 63 is preferably constantly in contact with the cam 55, such that rotation of the cam 55 exerts a movement on the arm 63 depending on the angular position of the cam 55. Thus, the stud-holder 31 of the index system 20 rotates about the second bearing 28. Such an index system 20 equipped with a cam 55 allows the stiffness of the balance spring 25 to be varied linearly.

To keep the arm 63 of the stud-holder 31 in contact with the cam 55, the index system 20 includes a spring 57 exerting a return force on the stud-holder 31.

In FIG. 4, the spring 57 is substantially horseshoe-shaped, with a first end 58 of the spring connected to the balance bridge 22, and a second end 59 of the spring 57 surrounding a retaining stud 60 extending from the stud-holder 31. The spring 57 is arranged in a hollow 61 made in the balance bridge 22 below, on the balance 23 and the balance spring 25 side. The balance bridge 22 comprises a through-hole 62 opening into the hollow 61, with the retaining stud 60 extending into the hollow 61 through the through-hole 62. The through-hole 62 is dimensioned to allow the retaining stud 60 to move as the stud-holder 31 rotates relative to the balance bridge 22.

Thus, the spring 57 exerts a return force on the stud-holder 31 of the index system 20, the return force having the function of constantly maintaining the arm 63 of the stud-holder in contact with the cam 55. When the cam 55 is acted upon, the stud-holder 31 rotates to move the first stud 34 relative to the second stud 35, while being subjected to a return force exerted by the spring 57, to allow the arm 63 of the stud-holder 31 to contact the cam 55, in particular when the peripheral wall 64 of the cam 55 moves away from the arm 63.

The index system 20 is configured to adjust the rate of the regulating member 1 with a resolution of less than or equal to 1 second per day, preferably less than or equal to 0.5 seconds per day, or even less than or equal to 0.1 seconds per day. The configuration of the regulating member 1 allows such precision to be achieved.

Adjustment marks 49 are also arranged on the cam 55. Therefore, in order to adjust the index system 20, the cam 55 is moved, for example by means of an adjustment knob (not shown in the figures), which is arranged on the cam 55 and which can be rotated. Thus, the cam 55 is orientated according to a preferred guide mark in order to adjust the index system 20.

Preferably, the adjustment marks 49 correspond to the resolution. In other words, the difference between two consecutive guide marks allows the rate to be changed by one second, 0.5 seconds or even 0.1 seconds per day. In FIG. 6, the resolution of the adjustment marks 49 is 0.1 seconds.

FIGS. 6 to 8 diagrammatically show a second embodiment of a regulating member 40 according to the invention. In this embodiment, the stud-holder 71 and the spring 72 are in one piece, preferably made of the same material. In all other respects, the regulating member 40 is identical to the first embodiment.

The stud-holder 71 comprises a single projection 81 carrying the first stud 34. The stud-holder 71 includes the spring 72 in place of the second projection.

The spring 72 is elongate and extends from the ring 737 of the stud-holder 71 on the side opposite the arm 81. The spring 72 is U-shaped and rests on the balance bridge 52, when the stud-holder 71 is mounted in the regulating member 40. A first end 75 of the U is integral with the ring 77 of the stud-holder 71, while a second end 76 is free.

The second end 76 is inserted into a hole in the balance bridge 52. The second free end 76 comprises, for example, a bend 79 to hook the hole. Thus, the second end 76 of the spring 72 is supported in the hole to lock the spring 72 on this side.

Thus, when the stud-holder 71 rotates, under the effect of the movement of the cam 55, the spring 72 is more or less stressed, and exerts a return force on the stud-holder 71 to hold the arm 63 against the cam 55, whatever its position.

Alternatively, the second free end 76 could be wedged against an edge 78 of the balance bridge 52.

Apart from these differences, the regulating member 40 of the second embodiment has identical features to that of the first embodiment, in particular relative to the cam 55, the first stud 34 and the second stud 35, as well as the balance spring 25.

Such a stud-holder 71 makes it easier to fit same within the regulating member, as there is only one component to be arranged on the balance bridge. Storage is also simplified, as a single component replaces two components.

It goes without saying that the invention is not limited to the embodiments of regulating members described with reference to the figures and alternatives can be considered without leaving the scope of the invention.

1. A regulating member (1, 40) for a horological movement comprising:
an inertial mass, including a balance (23);
a balance spring (25);
a balance bridge (22); and
an index system (20) for adjusting the rate of the balance spring (25), the index system (20) comprising a stud-holder (31, 71) including a first stud (34) on which the balance spring (25) is mounted,
wherein the balance bridge (33, 53) includes a second stud on which the balance spring (25) is also mounted, the stud-holder (31, 71) being rotatable relative to the balance bridge (22, 52) in order to adjust the rate of the regulating member (1, 40).

2. The regulating member according to claim 1, wherein the balance spring (25) comprises a coiled ribbon (2) and means for adjusting the stiffness of the balance spring, which means are provided with a flexible element (5) arranged in series with the coiled ribbon (2), the second stud (35) being mechanically connected to the flexible element (5).

3. The regulating member according to claim 2, wherein the adjustment means comprise prestressing means (6) for applying a variable force or torque to the flexible element (5), the first stud (34) being mechanically connected to the prestressing means (6).

4. The regulating member according to claim 3, wherein the flexible element (5) and the prestressing means (6) are arranged between the first stud (34) and the second stud (35), the first stud (34) being movable relative to the second stud (35) to actuate the prestressing means (6), the displacement of the first stud (34) relative to the second stud (35) modifying the stiffness of the balance spring (25).

5. The regulating member according to claim 4, wherein the prestressing means (6) include a lever (14) connected to the flexible element (5), the first stud being integral with a free end (15) of the lever (14).

6. The regulating member according to claim 3, wherein the prestressing means (6) include a rigid structure arranged in parallel with the flexible element (5), the lever (14) being connected to the rigid structure.

7. The regulating member according to claim 2, wherein the flexible element (5) is connected to a rigid support (17), the second stud (35) being integral with the rigid support (17).

8. The regulating member according to claim 1, wherein the index system (20, 60) comprises a rotatable cam (55), the cam (55) cooperating with the stud-holder (31, 71) to cause it to rotate.

9. The regulating member according to claim 8, wherein the stud-holder (31, 71) comprises an arm (63) in contact with the cam to be able to rotate the stud-holder.

10. The regulating member according to claim 1, wherein the index system (20, 60) comprises a return spring (57, 72) exerting a spreading force between the stud-holder (31, 71) and the balance bridge (22, 52).

11. The regulating member according to claim 10, wherein the stud-holder (31, 71) and the spring (57, 72) are in one piece, preferably made of the same material.

12. The regulating member according to claim 1, wherein the stud-holder (31, 71) is arranged on the balance bridge (22, 52) around a bearing (28) on the balance staff (24).

13. A horological movement, comprising the regulating member (1, 40) according to claim 1.

14. A timepiece, comprising the horological movement according to claim 13.
